(19) United States
(12) Patent Application Publication
(10) Pub. No.: US 2003/0231351 A1
(43) Pub. Date: Dec. 18, 2003

(54) Apparatus and method for digitally analyzing a photographic film having individual images

(75) Inventors: Hans-Georg Schindler, Holzkirchen (DE); Volker Josel, Munchen (DE); Werner Oberndorfer, Munchen (DE)

Correspondence Address: DARBY & DARBY P.C., P. O. BOX 5257, NEW YORK, NY, 10150-5257, US

(73) Assignee: AGFA-GEVAERT AKTIENGESELLSCHAFT, Leverkusen (DE)

(21) Appl. No.: 10/391,449

(22) Filed: Mar. 18, 2003

Related U.S. Application Data
(63) Continuation of application No. PCT/EP01/10528, filed on Sep. 12, 2001.

(30) Foreign Application Priority Data
Sep. 19, 2000 (DE) 100 46 357.6

(51) Int. Cl. H04N 1/21; G06F 15/00; G06K 1/00

(52) U.S. Cl. 358/302; 358/1.2

(57) ABSTRACT

An apparatus and method is disclosed for digitally reproducing images on photographic film. A main scanning element scans at least one image of the film during a main scanning operation and produces main scanning values from which at least one film-specific characteristic value can be obtained. Image processing means are provided for modifying the main scanning values on the basis of the film-specific characteristic values determined, at least one part of said main scanning values comprising main scanning values of at least two individual images.

The present invention relates to a method and apparatus for reproducing photographic images. More particularly, this invention relates to a method and apparatus for digitally reproducing film images wherein film-specific color correction values are determined during a main scanning operation.

### BACKGROUND OF THE INVENTION

Film brands from different manufacturers are made differently and therefore posses different film masks with different coloring (referred to sometimes as a “film specific characteristic value”). This coloring must be corrected whenever paper copies of the filmed images are made. In conventional photography, this is done by means of a corresponding coloration of the copier light. In a digital process, it is done by means of corresponding image processing.

Commercially available films are provided with a DX code from which the manufacturer can be inferred. In the production of paper copies of films, the DX code normally is read and the coloration of the film mask determined by way of the film type that is recognized. The images can then be corrected accordingly.

However, the basic coloring of films can change significantly, for example, as a result of different storage. A film which has been stored for a long time at high temperatures will have a different coloring than a film which has been stored for a short time at low temperatures and then developed quickly. Such differences cannot be taken from the DX code.

A method was therefore introduced in which every film, or at least a large number of the individual images of each film, was first scanned at low resolution and the basic coloring or the film mask of the entire film calculated from the values measured. For the conventional analog method of producing paper copies, the copier light was then colored to correct the coloration of the specific film. Independently, an exposure correction was determined for each individual image and combined with the film specific data for each individual exposure. For digital processes, the image date was processed similarly.

Consequently, for a conventional method of producing paper images, a large section of film was analyzed before the first image of the film was copied onto photo paper in an exposure unit. Such a device was therefore only equipped with a scanner having a relatively low resolution and separated from the exposure unit, for example, by way of a loop memory. With the introduction of digital methods, the exposure unit was replaced by a high-resolution scanner.

Publication DE 198 05 048 A describes such a method and apparatus for digitally analyzing photographic films having a plurality of individual images. A film is first scanned with a low resolution by a preliminary scanning device in which the optical density of the film is measured, advantageously in the colors blue, green and red. Subsequently, the positions of the individual images on the film and color-specific characteristic values for the exposure control during a subsequent main scanning operation are determined at a second, higher resolution. This main scanning operation takes place at a time during which the individual image to be scanned has come to rest.

The main scanning values are the color density values for each pixel of an image. These image values are corrected with the film specific characteristic values as well as image specific characteristic values. Such image specific characteristic values, for example, include artificial light correction, skin tone correction, red eye correction and unsharp mask. The position of the image is also determined but this is not necessarily done by the main scanner and can, for example, be done by a stepper motor which transports the film. The resultant image data is then used to generate a paper print, for example, by means of a laser printer of LCD printer. Systems of this type are illustrated and described in U.S. Pat. Nos. 5,781,276, 6,037,109 and 5,155,524.

While the film is being transported through the preliminary scanning device at a relatively high speed, three lines of the film perpendicular to the direction of movement of the film are projected onto three sensor lines of the preliminary scanning device. The sensor lines are each covered with a color filter in order to obtain separations of the film in the colors red, green and blue. Alternatively, a line of the film, perpendicular to the direction of movement of the film, may be divided into a red, green and blue lines by a color separator, and the lines then projected onto the three sensor lines. Consequently, each line-shaped section of the film, (hereinafter, a “preliminary scanning section”) is simultaneously imaged onto the three sensor lines.

The preliminary scanning values are transferred into a computer in which the positions of the individual images and the color-specific characteristic values are determined from the color separations of the entire film. For the main scanning operation at the higher resolution, the film is positioned by means of a positioning device in such a way that an individual image on the film (or a portion of the image) is located in the imaging ray path of a main scanning device and projected onto a main scanning element, in this case a surface CCD array. For this purpose, the size of the surface CCD array may be such that the color density of an entire individual image is analyzed, or a smaller array may be shifted with several partial sections of the image being recorded and compiled. The imaging operation can take place either directly or by way of a lens. The light for the main scanning process can be colored by way of a corresponding filter assembly and the exposure can take place sequentially in the three colors red, green and blue. The color-specific characteristic values determined in the preliminary scanning operation are taken into consideration in the exposure control for the main scanning operation.

Publication DE 28 40 287 discloses a method for determining the exposures, individually controlled in the individual colors, from the preliminary scanning values of the preliminary scanning operation. This method is also known as a TFS (total film scanning) method.

A disadvantage of the device and method described in publication DE 198 05 048 A is that the light source, lenses, filters and sensors used in the prescanner and the main scanner must be matched with great spectral-precision. If the spectral sensitivities of the prescanner and main scanner differ, the image data for the main scanner is corrected with characteristic values determined from different measured values in the prescanner. This leads to unsatisfactory results. However, since different optical systems, exposure elements and sensors are generally used for the two scanning devices, such spectral matching is difficult. In particular, the high demands that must be satisfied for this purpose by the spectrally effective components of the two scanning devices increase the production costs of the device. Higher production costs must also be expected if almost the same high-quality components are selected for the preliminary scanning device and the main scanning device.

It is possible to overcome this disadvantage by carrying out the preliminary scanning operation and the main scanning operation with a single scanning device. Such a device, however, is not suitable in large photofinishing laboratories where approximately one hundred film strips are spliced together and scanned successively in batches. The spliced films must first be scanned completely by the scanning device in a preliminary operation and then undergo the main scanning operation in the same scanning device. This procedure is too time-consuming to be practicable.

It is also a disadvantage of the device and method described above that the entire film, or at least a sizable portion thereof, must be scanned in the preliminary scanning operation prior to the main scanning operation in order to determine the color-specific characteristic values for the main scanning operation which are characteristic for the entire film. This is a lengthy procedure.

Accordingly, it is an object of this invention to provide a method and apparatus of the type described in which the quality of the digital analysis of the film is increased without decreasing the speed and/or increasing the production costs.

### SUMMARY OF THE INVENTION

Pursuant to the invention, this objective is accomplished by determining at least one characteristic value specific to the film (e.g. film color behavior) from at least part of the main scanning values of two or more individual images, on the basis of which the stored main scanning values can be modified in an automatic image processing operation.

The invention is based on the finding that certain film-specific characteristic values which can be determined in a preliminary scanning operation, can also be determined in a main scanning operation, if the main scanning values can be modified (e.g. in an automatic image processing operation) by the film-specific characteristic value that is formed. In this way, the number of variables to be determined and the demands on the precision of the variables to be determined during the preliminary scanning operation can be reduced significantly, so that matching of the spectrally active components used during the preliminary scanning operation to the components used for the main scanning operation can be avoided. In numerous embodiments of the invention, it is possible to eliminate preliminary scanning.

According to a first, advantageous embodiment of the invention, at least two main scanning values are combined in order to determine at least one film-specific characteristic value. For example, in order to be able to carry out the TFS method mentioned above to determine at least one film-specific characteristic value, including the TFS calculations, with the help of the invention and within a reasonable period of time, it is advantageous to reduce the main scanning values, which are generally obtained at high resolution, by means of a suitable combination, for example, by the use of appropriate software to average the main scanning values for a predetermined number of pixels.

Accordingly, at least one image (or part thereof) of the film can be scanned at a first resolution during the main scanning operation and a second resolution, which is less than the first resolution, can be achieved by combining the two main scanning values. Consequently, a resolution which corresponds, for example, to the resolution of the preliminary scanning operation of the state of the art, is achieved by combining the main scanning values. However, in contrast to the state of the art, this second resolution can be freely determined with the invention after the main scanning values have been recorded and is limited only in the upward direction by the first resolution. Particularly in the case of films which appear to be a problem, the second resolution can be increased subsequently to improve the image processing.

In a particularly advantageous embodiment of the invention, each image can be detected in color separations of the three basic colors (red, green and blue) during the main scanning operation, and the selected film-specific characteristic value can be characteristic of the color behavior of two or more individual images. This enables the TFS method to be used. In the TFS method, a color tinge of the film, for example, can be determined on the basis of the color behavior of several individual images of the film. Such a color tinge can be corrected by the invention, since the main scanning values can be modified on the basis of the characteristic value for this color tinge. With regard to the TFS method, reference is made particularly to the publications DE 28 40 287 and DE 19 14 360 (which are hereby incorporated herein by reference) in which the method is explained in detail. It is a particular advantage of this embodiment of the invention that it is unnecessary to perform a preliminary scan of the entire film before the main scanning operation in order to form the film-specific characteristic value which is characteristic of the color behavior of the film.

Furthermore, the film-specific characteristic value can include the position of at least one individual image, so that the individual image positions do not necessarily have to be determined during a preliminary scanning operation.

The invention also contemplates a preliminary scanning process in which a preliminary scanning section of the film can be scanned to provide at least one parameter which is relevant for the main scanning process. For example, the parameter can comprise the position of an image on the film and/or the DX code on the film and/or at least one perforation of the film. A very simple and cost-effective preliminary scanning element can be used to detect the position of an image and/or the DX code on the film and/or a perforation of the film. Furthermore, with such a preliminary scanning operation, the film does not have to be scanned completely before the main scanning operation, so a substantial amount of time is saved.

The preliminary scanning section can be scanned with a resolution that is less than the resolution during the main scanning operation, since parameters which require a high-resolution detection of the film, do not have to be determined during the preliminary scanning operation. The resolution during the preliminary scanning operation can therefore be less than the resolution achieved by combining two main scanning values to form a film-specific characteristic value.

During the preliminary scanning operation, the preliminary scanning section can also be detected in color separations of the three basic colors red, green and blue, in order to obtain characteristic values for the exposure control during the main scanning operation. This feature of the invention is particularly useful if the film is to be digitally copied and has a strong color tinge, in which case a rough correction can be performed by the exposure control.

Pursuant to the invention, the above objective is also accomplished by a method, which digitally records a film having several individual images and comprises the following steps. To begin with, at least one image, or part thereof, is scanned during a main scanning operation by means of a main scanning element. The main scanning values scanned during the main scanning operation are stored. Subsequently, at least one film-specific characteristic value is formed from at least part of the main scanning values. This characteristic value is used for automatically processing images of the stored main scanning values, the selected main scanning values comprising main scanning values of at least two individual images.

Furthermore, the functions already mentioned above in connection with the inventive device can be realized by means of the inventive method.

### THE DRAWINGS

FIG. 1 is diagrammatic illustration of a preferred embodiment of the invention in which only a main scanning element is used; and

FIG. 2 is a diagrammatic illustration of a second embodiment of the invention which includes prescanning as well as main scanning.

### DETAILED DESCRIPTION

The drawing diagrammatically shows the construction of an example of apparatus 10 according to the invention for digitally reproducing the images on a photographic film 12. This example does not have a preliminary scanning device, since all of the film-specific characteristic values required are determined from the main scanning values recorded during the main scanning operation, the film-specific characteristic values providing a basis for subsequent automatic image processing of the main scanning values. These film-specific characteristic values comprise the positions of the individual images on the film 12, and color information, which is obtained from the main scanning values of the individual images. Two multi-color LED arrays 14 and 16 are used as exposure devices, the light from which initially is focused by means of array of lenses 18 and subsequently brought together using a dichroic beam splitter 20. The LED array 14 is made up of red and green LEDs and the LED array 16 comprises blue and infrared LEDs.

The light of the LED arrays 14 and 16 is brought together at the dichroic beam splitter 20 and passed over a condenser lens 22 through the mask of a film platform 24 onto an image of the film 12. The multi-colored light, which passes through the image is focused onto a beam splitter prism complex 28 by an imaging lens 26. The complex diverts the light onto different main scanning elements—implemented here by CCD arrays 30, 32, 34, 36—in accordance with the spectral portions. For example, the red color portion is imaged on the CCD array 30, the green color portion is imaged on the CCD array 32, the blue color portion is imaged on the CCD array 34 and the infrared color portion is imaged on the CCD array 36.

The color portions detected by the CCD array 36 are converted into defect signals, which provide data about defective locations in the film 12 and are stored in a storage element 38. The color portions, detected by the CCD arrays 30, 32, and 34, are also stored in the storage element as main scanning values. Gradually, by transporting the film 12, the other images of the film 12 are also scanned in the manner described above and the corresponding main scanning values are stored in the storage element 38.

The main scanning values are combined by means of a computer unit 40 in such a way, that the positions of the individual images on the film 12 can be determined with sufficient accuracy on the basis of the combined main scanning values. By determining the individual image positions, main scanning values stored in the storage element 38 can be assigned to the individual images of the film. These main scanning values, assigned to the individual images, can be combined in ranges for the TFS method, which is to be carried out subsequently, the number of the main scanning values combined for this purpose not having to be identical with the number of main scanning values which were combined for determining the individual image positions.

In the TFS process, two color density difference values are then formed in the computer unit 40 for each region of the individual images, the first color density difference value being the difference between density values of two basic colors (red, blue, green) and the second color density difference being the difference between a density value of one of the two basic colors and a density value of the third basic color. Also, the average density is formed from the three basic colors for each region of the individual images and a functional relationship with the average density, which describes the color behavior of the film is produced for a larger number of images of the film, by assigning the color density difference values to the related average density values. Using this functional relationship, the film-specific characteristic values are formed on the basis of the average density of an individual image. The main scanning values stored in the storage element 38 are modified in an automatic image processing operation on the basis of the film-specific characteristic values formed in this manner.

In an alternative TFS method, the average density is formed for each scanned region from the combined main scanning values of all three basic colors. Three functional relationships are produced which describe the color behavior of the film for a larger number of images of the film by assigning density values of the three basic colors to the related average density values of the images. Using these functional relationships, the film-specific characteristic values are formed on the basis of the average density of an individual image. In this alternative TFS method, the main scanning values stored in the storage unit 38 are also modified in an automatic image processing operation on the basis of the film-specific characteristic values.

Furthermore, the combined main scanning values of the individual images can be checked to determine whether there are any regions in which the density values differ clearly from the average density of the totality of the individual images. If this is the case, different image processing methods can be used for these regions, depending on the color dominance present.

With regard to further details of the TFS method, reference is made to the publication DE 28 40 287.

In an alternative example of the invention, the determination of the individual images and the TFS method explained above can be carried out more or less simultaneously in a single step.

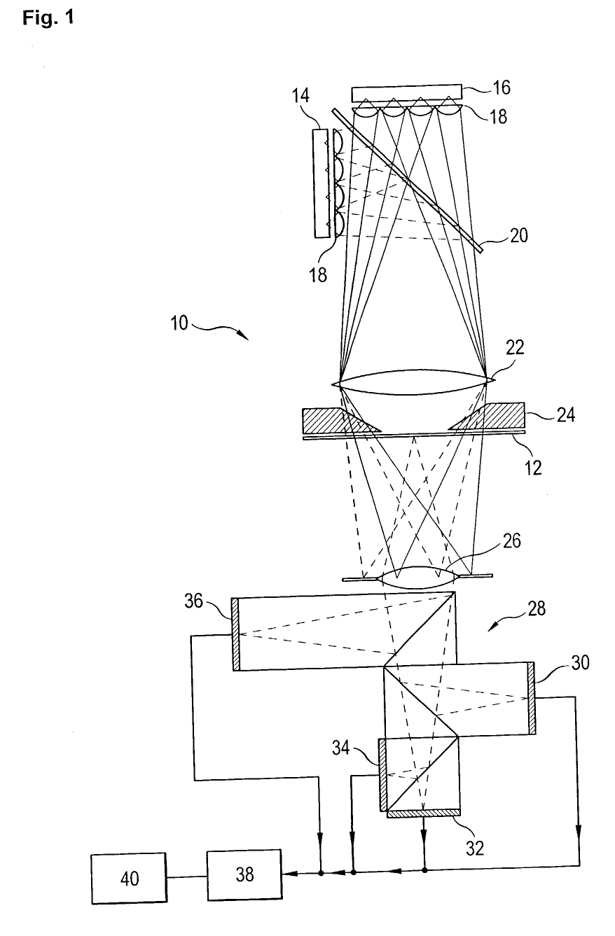

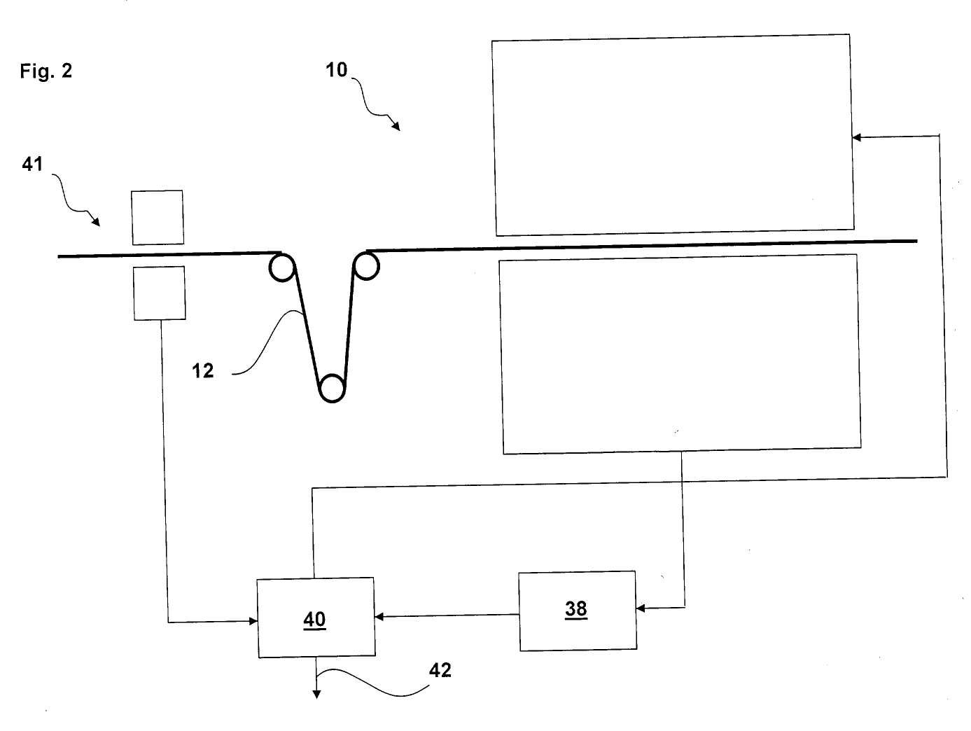

Another embodiment of the invention may include the structure shown in FIG. 1, and a preliminary scanning device, by means of which the individual image positions of the film are determined and a DX code on the film is read. FIG. 2 illustrates such a system comprising a main scanner 10 and a prescanner 41. Prescanner 41 may be a tri-linear-scanner which scans the film in three colors, line by line. The computer 40 produces a signal on line 42 which is fed to the image printer to reproduce the individual images on the film 12. The computer 40 also couples a control signal back to the main scanner 10 to control the exposure time as calculated by the computer.

In the preliminary scanning operation, the film is analyzed section by section, for example, in the three basic colors blue, green and red, and at a resolution which is lower than that of the main scanning operation. The resolution can also be lower than that attained by combining the main scanning data, as described above. Aside from the preliminary scanning values obtained, it is also possible to use perforations in the film to determine the positions of the individual images on the film. If the positions of the individual images on the film are already determined ahead of the main scanning operation, as they are in this example, these individual images are analyzed digitally during the main scanning operation. If an individual image of the film has already been identified, the main scanning operation can be carried out immediately afterwards, without first having to subject the entire film to a preliminary scanning operation. The preliminary scanning operation and the main scanning operation of the entire film can therefore be carried out partly in parallel. If parameters, which are characteristic of the color behavior of the entire film are to be taken into consideration in the main scanning operation, and also determined during the preliminary scanning operation, the main scanning operation can only be carried out after the preliminary scanning operation has been completed. The main scanning operation is carried out as in one of the examples above.

The distinguishing features of the individual examples described can be combined in any desired manner.

We claim

1. A device for digitally reproducing a film (12) with several individual images, comprising a main scanning element (30, 32, 34, 36) for scanning at least one image of the film (12) during a main scanning operation, a storage element (38) for storing the main scanning values obtained during the main scanning operation, wherein at least one film-specific characteristic value can be obtained from the main scanning values, and image processing means for modifying the stored main scanning values on the basis of said film-specific characteristic values, at least one part of said main scanning values comprising main scanning values of at least two individual images.

2. The device of claim 1, wherein at least two main scanning values can be combined to form the film-specific characteristic value.

3. The device of claim 2, wherein the scanned image of the film (12) is scanned at a first resolution during the main scanning operation, and a second resolution which is lower than the first resolution is achieved by combining the at least two main scanning values.

4. The device of claim 1, wherein the at least one image is detected in color separations of the three basic colors during the main scanning operation, and at least one film-specific characteristic value is characteristic of the color behavior of at least two individual images.

5. The device of claim 1, wherein the at least one film-specific characteristic value comprises the position of the at least one individual image.

6. The device of claim 1, wherein the device (10) comprises a preliminary scanning element for scanning at least part of the film (12) during a preliminary scanning operation, at least one characteristic value which is relevant for the main scanning operation being determined during the preliminary scanning operation.

7. The device of claim 6, wherein the at least one characteristic value comprises the position of the image on the film (12) and/or one DX code on the film (12) and/or at least one perforation of the film (12).

8. The device of claim 6, wherein the at least one image of the film (12) is scanned during the main scanning operation using a first resolution and the part of the film scanned during the preliminary scanning operation is scanned at another resolution which is less than the first resolution.

9. The device of claim 8, wherein, by combining at least two main scanning values to form the at least one film-specific characteristic value, a second resolution is achieved and the further resolution during the preliminary scanning operation is less than the second resolution.

10. The device of one of claim 6, wherein the film is analyzed in color separations of the three basic colors, during the preliminary scanning operation.

11. In a photographic copying process, a method for digitally analyzing a film (12) having a plurality of individual images, comprising the following steps:
(a) scanning at least one part of the film (12) during a main scanning operation by means of a main scanning element (30, 32, 34, 36) to determine main scanning values;
(b) storing the main scanning values determined during the main scanning process;
(c) determining a film-specific characteristic value from at least one main scanning value from at least two individual images; and
(d) using said film-specific characteristic value for determining the main scanning values stored in step (b).

12. The method of claim 11, wherein, at least two main scanning values are combined in step (c).

13. The method of claim 12, wherein the scanning in step (a) is carried out at a first resolution and, by combining said two main scanning values, a second resolution is obtained which is less than the first resolution.

14. The method of claim 11, wherein the main scanning values determined in step (a) are detected in color separations of the three basic colors red, green and blue in step a) and said film-specific characteristic value is characteristic of the color behavior of the at least two individual images.

15. The method of claim 11, wherein the at least one film-specific characteristic value comprises at least the position of an individual image.

16. The method of claim 11, wherein a preliminary scanning operation of at least one preliminary scanning section of the film is performed before and/or during the main scanning operation by means of a preliminary scanning element, during which operation at least one preliminary characteristic value relevant for the main scanning operation is formed.

17. The method of claim 16, wherein the at least one preliminary characteristic value comprises at least one position of the image to be scanned during the main scanning operation and/or one DX code on the film (12) and/or at least one perforation on the film (12).

18. The method of claim 16, wherein the scanning in step (a) takes place at a first resolution and the preliminary scanning operation is carried out at another resolution which is less than the first resolution.

19. The method of claim 18, wherein, by the combination of the two main scanning values in step (c), a second resolution is attained, and wherein the further resolution during the preliminary scanning operation is less than the second resolution.

20. The method of claim 16, wherein the at least one preliminary scanning section during the preliminary scanning operation is detected in the color separations of the three basic colors red, green and blue.
